(19) United States
(12) Patent Application Publication
(10) Pub. No.: US 2024/0179824 A1
(43) Pub. Date: May 30, 2024

(54) A METHOD OF JOINING A NODE DEVICE INTO A WIRELESS NETWORK AND A NODE DEVICE

(71) Applicant: SIGNIFY HOLDING B.V., EINDHOVEN (NL)

(72) Inventors: JUN YAO, SHANGHAI (CN); BOFENG LI, SHANGHAI (CN); PEILIANG DONG, SHANGHAI (CN); XUWEN ZHOU, SHANGHAI (CN)

(21) Appl. No.: 18/282,167

(22) PCT Filed: Mar. 15, 2022
(86) PCT No.: PCT/EP2022/056633

§ 371 Date: Sep. 14, 2023

(30) Foreign Application Priority Data
Mar. 22, 2021 (WO) PCT/CN2021/082075
Jul. 13, 2021 (EP) 21185371.8

(51) Int. Cl. H05B 47/175

(52) U.S. Cl. CPC H05B 47/1985

(57) ABSTRACT

A method of joining a node device into a wireless network, the network created by a coordinator device and comprising a plurality of node devices divided into a number of groups. The method performed by one of the node devices and comprises the steps of: receiving a beacon message from the coordinator device at a first time instant; obtaining a group label for the node device based on the number of groups; determining a joining interval for determining a joining time instant for the node device; and transmitting a joining request to the coordinator device, at a joining time instant determined based on a starting reference time instant plus a joining period. The transmission step is repeated until an association response is received from the coordinator device, and a joining period for determining a joining time instant of a subsequent one of two consecutive transmissions is reduced comparing to a joining period for determining the joining time instant of the previous one of the two consecutive transmissions.

### TECHNICAL FIELD

The present disclosure generally relates to the field of wireless networks, and more specifically, to a method of joining a node device into a wireless network and a node device.

### BACKGROUND

Electric or electronic devices, such as lighting devices and Internet of Things, IoT, devices, and devices supporting enhanced Machine-Type Communication, eMTC, for example, all of which comprise data communication capabilities, are frequently deployed in networks comprised of a plurality of interconnected devices.

These devices, generally called node devices or terminal devices, or router devices, depending on their roles in different networks, may comprise a communication interface, such as a network adapter or transceiver module, for communication between node devices and possibly also with remote devices, such as a backend device or backend server.

The communication interface may operate in accordance with a network protocol for exchanging data by networked devices or nodes, such as designated ZigBee™, Bluetooth™, as well as WiFi based protocols for wireless networks, and wired bus networks such as DALI™ (Digital Addressable Lighting Interface), DSI (Digital Serial Interface), DMX (Digital Multiplex), KNX (and KNX based systems), and proprietary communication technologies and protocols, for example.

The communication interface may further operate in accordance with a wireless mobile communication standard, such as designated 2G/3G/4G/5G cellular communication, and other long-range wireless communication technologies like Long Range Wide Area Network, LoRaWAN, and Narrowband IoT, NB-IoT, or proprietary communication technologies, and/or a wired data exchange communication technology, for example.

With IoT node devices, such as ZigBee node devices, commissioning is the first step to establish or form a wireless IoT network. A necessary and important method for forming a wireless IoT network is the so-called auto-join. The time needed to form a network by auto-join is an important factor to consider, this is due to the fact that fast and convenient network formation is desirable for each and every customer.

Auto-join for a large scale wireless network, such as a ZigBee based lighting system comprising many lighting fixtures, may take a long time. As an example, forming a network with 200 node devices may take more than 30 minutes.

The long time needed for forming the network by auto-join is due to several reasons. In the first place, the number of wireless packets from the many node devices transmitted in the network during the auto-join procedure is large. Secondly, the bandwidth available for processing the wireless packets is normally limited in the network. Thirdly, the coordinator device handling the joining requests for the node devices may have restricted processing power. In the last place, a complex authentication process is used by the trust center for authenticating each node device. Those factors all together account for the long time needed by the auto-join procedure.

One way of tackling the above problem is allowing more bandwidth for processing the wireless packets related to the joining requests from various node devices. However, such a solution is not always viable due to hardware limitations and other factors.

Therefore, there is a genuine need for a method of joining node devices into a wireless network which may accelerate the auto-join process while ensure a quick and reliable commissioning of the wireless network.

### SUMMARY

In a first aspect of the present disclosure, there is presented a method of joining a node device into a wireless network, the network created by a coordinator device and comprising a plurality of node devices divided into a number of groups, the method comprising the steps of:
receiving, by the node device, a beacon message from the coordinator device at a first time instant, the beacon message received in response to a request message from the node device and comprising network information;
obtaining, by the node device, a group label for the node device based on the number of groups;
determining, by the node device, a joining interval for determining a joining time instant for the node device;
determining, by the node device, a first joining time instant for the node device, whereby the first joining time instant is the first time instant plus a joining period proportional to the joining interval and the group label;
transmitting, by the node device, a joining request to the coordinator device, at the first joining time instant;
when an association response is not received from the coordinator device; determining, by the node device, a consecutive joining time instant for the node device, wherein the consecutive time instant is a joining time instant of adjacent previous transmission step plus a joining period less than that of adjacent previous transmission step;
transmitting, by the node device, a consecutive joining request to the coordinator device at the consecutive joining time instant;
wherein the determination of the consecutive joining time instant and the transmitting of the consecutive joining request are repeated until an association response is received from the coordinator device.

In other words, the first aspect of the present disclosure can be alternatively described as follows. There is presented a method of joining a node device into a wireless network, the network created by a coordinator device and comprising a plurality of node devices divided into a number of groups, the method comprising the steps of:
receiving, by the node device, a beacon message from the coordinator device at a first time instant, the beacon message received in response to a request message from the node device and comprising network information;
obtaining, by the node device, a group label for the node device based on the number of groups;
determining, by the node device, a joining interval for determining a joining time instant for the node device;
transmitting, by the node device, a joining request to the coordinator device, at a joining time instant determined based on a starting reference time instant plus a joining period;
wherein the transmission step is repeated until an association response is received from the coordinator device;
a starting reference time instant and a joining period for determining a joining time instant of a first transmission step are respectively the first time instant and a period proportional to the joining interval and the group label;
a starting reference time instant and a joining period for determining a joining time instant of a subsequent one of two consecutive transmission steps are respectively a joining time instant of a previous one of the two consecutive transmission steps and a period reduced comparing to a joining period for determining the joining time instant of the previous one of the two consecutive transmission steps.

The present disclosure is based on the insight that dynamic and adaptive joining time control together with grouping of node devices to join a wireless network may be used to effectively shorten the time needed for commissioning a wireless network via auto-join. It is especially advantageous for large-scale wireless networks comprising a large number of node devices, such as a ZigBee based lighting system comprising hundreds of lighting fixtures.

For implementation of the solution of the present disclosure, a node device to join a wireless network, upon transmitting a request message such as a beacon request message to a coordinator device which has created the network to join, will receive a message such as a beacon (response) message at a certain time instant, here referred to as a first time instant. This is the reference time instant for determining when the node device shall start to transmit a joining request such as an association request to the coordinator device.

The node device then decides a group that it belongs to by deriving a group label based on the number of groups comprised in the network. Together with a joining interval that may be selected, the node device can determine a joining time instant when it will transmit the joining request to the coordinator device, requesting to join the wireless network.

Node devices comprised in the wireless network can thereby differentiate their joining time by automatically being allocated into different groups and only transmitting the joining request at a specific joining time instant.

When the joining request transmitted by the node device is handled by the coordinator device successfully, the node device will receive a joining response from the coordinator device. Thereafter, authentication is performed between the node device and coordinator device to complete the joining process.

However, if no joining response is received by the node device, that is, the first joining attempt has failed, the node device will try to join the network for a second time. By this time, the number of node devices still waiting to join the wireless network is smaller as many node devices have already joined the wireless network successfully. Therefore, the waiting time or joining period is reduced comparing to the previous joining attempt.

The adaptive joining period designed for each joining attempt helps to reduce the overall auto-join time significantly.

The transmission of the joining request is repeated until a joining response is received. This helps to ensure that the node device can indeed join the wireless network successfully.

In an example of the present disclosure, the method further comprises, subsequent to the receiving step, a step of:
receiving, by the node device, a second beacon message comprising the number of groups from the coordinator device.

In this example, there is another beacon message from the coordinator device, in addition to the beacon message received at the first time instant. The beacon message is configured for transmitting to the node device the number of groups of the node devices comprised in the wireless network.

This requires no modification of the first beacon message, which may be for example a standard beacon response message.

As an alternative, the number of groups may also be comprised in the beacon message received at the first time instant. This helps to save the number of messages exchanged between the node device to join and the coordinator device, at the expense of requiring modification to the beacon message received at the first instant to further include the number of groups.

Alternatively, in another example of the present disclosure, the number of groups is provided to the node device via a software or by reading from a data file available to the node device.

The number of groups is thus configured at the end of node devices, which helps to reduce the number of network packet transmitted between the coordinator device and the node devices thereby saving bandwidth.

It can be contemplated by those skilled in the art that the number of groups is dependent on a size of the wireless network or a number of node devices comprised in the wireless network. As an example, if 200 node devices are to form a single network, the node devices may be divided into 5 groups. In this case, the number of groups is five.

In an example of the present disclosure, determining, by the node device, a group label for the node device based on the number of groups comprises:
determining, by the node device, the group label for the node device as a remainder obtained by a random number generated by the node device modulating the number of groups.

The module operation performed by the node device allows it to be assigned or allocated with a group label randomly. The group label has a range of 0 to n−1, n being the number of groups. This is a simple and efficient way of grouping the node devices of the wireless network, which is the basis for differentiating the joining time of the node devices.

Alternatively, in an example of the present disclosure, determining, by the node device, a group label for the node device based on the number of groups comprises:
determining, by the node device, the group label for the node device as a remainder obtained by a Medium Access control, MAC, address of the node device modulating the number of groups.

Instead of using a randomly generated number, the MAC address of the node device may also be conveniently used for determining the group label for the node device. As each node device has a different MAC address, it is very convenient to use the MAC address for grouping the node devices.

In an example of the present disclosure, the joining interval for determining a joining time instant for the node device is determined based on a number of node device in a group comprising the node device.

The joining interval may be experimentally decided based on the number of node device in a group comprising the node device. As an example, a group interval of 60 seconds may be set for a group comprising 40 node devices.

Specifically, the coordinator devices may determine the group number and the joining interval. The joining interval is related to the node devices in each group and the deployment of these node devices. Typically, the joining interval is less than the commissioning time required for all node devices in a group to join the network, which allows certain competition during the commissioning.

As an example, it normally takes more than one minute (for example, 1.5 minutes) for 40 node devices to join the wireless network completely. So the group interval may be set a little less than the required time. This helps to reduce the auto-join time while allowing a certain competition. Although some nodes device may be left to the next group, the whole auto-join duration is still short.

In an example of the present disclosure, the joining period for determining a joining time instant of the first transmission step is equal to a product of the joining interval and the group label.

This essentially differentiates the joining time of node devices of different groups. As a result, joining request from node devices of different groups are transmitted at different time instants, which significantly reduces the processing required by the coordinator device at each time instant.

In an example of the present disclosure, the joining period for determining the joining time instant of the subsequent one of two consecutive transmission steps is half of the joining period for determining the joining time instant of the previous one of the two consecutive transmission steps.

In case that the first joining attempt fails, the joining period or waiting time until the next joining attempt is reduced. In this specific example, it is half the joining period of the previous joining attempt. This helps to further reduce the overall joining time needed to form the wireless network.

It can be contemplated by those skilled in the art that other reduced joining period may also be selected, such as one third of the joining period of the previous joining attempt.

In a further example of the present disclosure, the joining period for determining the joining time instant of the subsequent one of two consecutive transmission steps is set to zero when the joining period for determining the joining time instant of the previous one of the two consecutive transmission steps is less than a threshold value.

This is in relation to the situation when a node device has tried several times to join the wireless network without success. At this time, the joining period may be reduced to less than for example 10 seconds. In this case, the joining period may be set directly to zero such that the node device does not have to wait any longer. This allows the node device to improve the chance of joining the wireless network successfully.

In an example of the present disclosure, the joining request other than the one in the first transmission step is processed with a higher priority by the coordinator device than joining request in the first transmission step.

The coordinator device processes the subsequent joining request(s) with a higher priority, this helps to avoid that one node device fails many times during the auto-join.

In an example of the present disclosure, a random delay is appended to each joining period.

A random delay in the form of a jitter may help to avoid packet collision from joining requests from different node devices.

In an example of the present disclosure, the method further comprising a step of authenticating each other by the node device and the coordinator device.

Sometimes a node device may not complete the joining process, and leave the network and try to join again. Authentication between the node device and coordinator device ensures that the node device is really joined into the network.

A second aspect of the present disclosure provides a node device arranged for joining a wireless network comprising a plurality of node devices divided into a number of groups according to the method of any of the previous claims.

In an example of the present disclosure, the node device is a lighting fixture. The lighting fixture operates according to the method of the first aspect of the present invention disclosure to join a wireless network.

A third aspect of the present disclosure, a computer program product is provided, comprising a computer readable storage medium storing instructions which, when executed on at least one processor, cause the at least one processor to carry out the method according to the first aspect of the present disclosure.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 schematically illustrates a diagram of an auto-join process for forming a wireless network comprising a plurality of node devices.

FIG. 2 schematically illustrates, in a flow chart type diagram, an embodiment of a method of joining a node device into a wireless network in accordance with an embodiment of the present disclosure.

FIG. 3 illustrates, schematically, an embodiment of a node device arranged for joining a wireless network in accordance with the present disclosure.

### DETAILED DESCRIPTION

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

The present disclosure is detailed below with reference to ZigBee based lighting devices functioning as node devices of a wireless network created by a coordinator device commissioning the lighting devices in the network. Those skilled in the art will appreciate that the present disclosure is not limited to commissioning a ZigBee based network of lighting devices, but is applicable for networks of a wide variety of node devices enabled with network communication connectivity, as indicated in the background part.

During the deployment of Internet of Thing, IoT, networks such as ZigBee networks, commissioning of a node device into a network may be realized via auto-join.

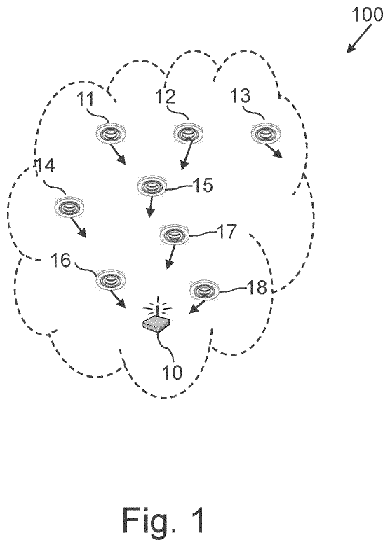

FIG. 1 schematically illustrates a diagram of an auto-join process for forming a wireless network 100 comprising a plurality of node devices 10-18. The network 100 is created by a coordinator device 10 which will transmit a network permit join command after creating the network.

In practice, when a node device 11-18 is powered up or manually put into a commissioning or auto-join state, the node device 11-18 will automatically handle all the steps needed to discover and join the network 100 available to join and establish relationships with other node devices in the network, by interaction with the coordinator device 10.

Specifically, when auto-joining state is initiated, a node device 11-18 shall periodically scan all start-up set channels for networks that are allowing joining. To find prospective networks to join, the joining node device 11-18 shall send a Beacon Request packets on each channel. When a beacon response is heard from the coordinator device 10 and it has the “Permit Joining” bit set, the node device 11-18 shall attempt to join that network.

When attempting to join the network 100, each node device 11-18 will transmit a joining request to the coordinator device 10, which will result in packet collision and various other issues that eventually results in prolonged totally join time of the whole network 100.

The present disclosure proposes a method of joining a node device into a wireless network, which accelerates the auto-join process and ensures a quick and reliable commissioning of the wireless network.

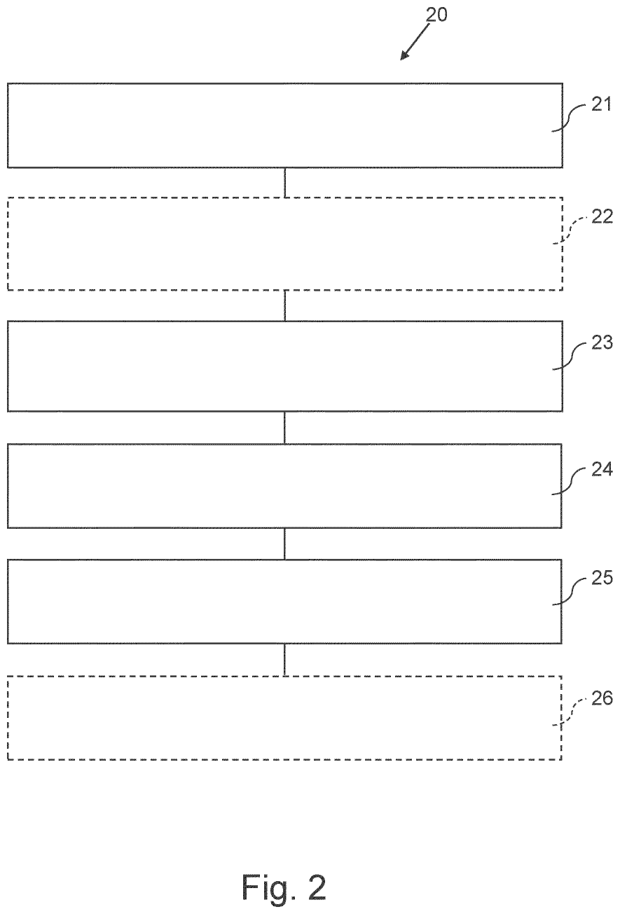

FIG. 2 schematically illustrates, in a flow chart type diagram, an embodiment of a method 20 of joining a node device into a wireless network in accordance with an embodiment of the present disclosure.

As a preparation step, a coordinator device such as a ZigBee coordinator first creates a network in a channel with less interference and sends out network permit join commands to allow node devices to join the network.

A node device such as a ZigBee node may then transmit a request message such as beacon request to the coordinator device. In response to the request message, at step 21, the coordinator device replies, at a time instant, with a response message such as beacon response.

There may be two consecutive beacon messages (responses) from the coordinator device. With the first beacon message, which is a general beacon response, the node device receives network information such as information on the ZigBee network. The second beacon message may be a special beacon response message used to inform 22 the node device of a number n of groups of node devices that the network comprises.

Sending the number n of groups of node devices by a subsequent and separate beacon message has the advantage of keeping the first beacon message in its standard form. The number n of groups of node devices may also be conveniently included in the first beacon message, which is modified in a way contemplatable by those skilled in the art to include the extra information on the number n of groups. This helps to keep the number of packet exchanged between the node devices and the coordinator devices low.

Alternatively, the number n of groups of the node devices may also be set in a software or configured separately using a data file available for the node device to read.

It can be contemplated by those skilled in the art that the number n may be determined according to a size of the network, that is, the number of node devices comprised in the network. As an example, for a network with 200 node devices, the node devices may be divided 5 groups, meaning n is set as 5.

At step 23, each node device may use the number of groups obtained from the first or second beacon message or a software or a data file to obtain a group label indicating a group that it belongs to.

Specifically, a node device may use its Medium Access Control, MAC, address or a newly generated random number to module the number of groups. The remainder, which has a range between 1 and n−1, is taken as the group label of this node.

The node devices in the network are thereby divided into n groups, which will allow them to subsequently transmit a joining request at differentiated time instants.

At step 24, a group joining interval t is selected, which will be used to calculate a group auto-join time instant for the node device.

The joining interval t may be set according to a number of node devices in each group. As an example, for groups comprising 40 node devices, the group interval as 60 seconds. This value is obtained according empirically.

Each node device will use its group label and the joining interval to determining a joining time instant when it shall transmit a joining request such as an association request to the coordinator.

The joining time instant of each node device is calculated with reference to a starting reference time instant and a joining period, which may also be referred to as a waiting period.

As an example, for a node device with a group label m, the joining time instant may be calculated with reference to a time instant when the beacon message indicating the network is available to join plus a joining period of m*t.

As a result, the node device will, at step 25, start sending the joining request to the coordinator device at the time point m*t from the time instant when the first beacon message is received. Of course, a random delay such as a jitter is usually appended to avoid packet collision between joining requests from different node devices.

In case the first joining request is successful, that is, an association response is received by the node device from the coordinator device, the node device will send out a device announce message. It will then prepare for second stage of auto-join as illustrated in step 26.

If the first joining request is not successful, for example, the node device may receive no association response from the coordinator device, the node device will send the joining request again, that is, the node device will make a second joining attempt.

The joining time instant for the second joining attempt may be calculated as a reduced joining period with reference to when the first joining request is transmitted. As an example, the joining period or waiting time now may be set to (m*t)/2, which means the group interval is half of the original value. The node device therefore only wait a half of the previous waiting time.

In case that the node device fails to join the network the second time, the group interval is further reduced as half of the previous value. The reason is that more and more nodes have joined the network so that the auto-join traffic is not so busy compared with previous time. If the group interval is reduced to a threshold value, such as less than 10 seconds, the group interval will be set as “0”. The node can restart the joining request just plus a random jitter.

It can be contemplated by those skilled in the art that the reduced joining period of the later one of two consecutive transmissions may be other than a half of the joining period of the earlier one of the two transmissions. Also the threshold for setting the group interval to zero may be chosen based on real life considerations, depending on the size of the network and the type of node devices.

At the other end, the coordinator devise handles the node joining request and also processes the authentication after the device announce. Sometimes, even if the nodes have announced their network short address, they do not complete the authentication process so that they leave the network and restart the auto-join process. These node devices will prolong the auto-join duration of the whole network.

In accordance with the present disclosure, the coordinator device records the auto-join status of all node devices. If a node device fails more than once to join the network and it is a legitimate node device authorized to join the network, the coordinator device will mark this node device as a node device with higher priority. The joining request and authentication process for this node device will be processed with relatively high priority.

In case there are many joining requests arriving simultaneously, the node device which failed more times will be handled first. Using this method, the authentication process could be shortened for those node device to avoid the time out failure of authentication. The node devices failed more times will be given as a higher processing level to avoid that one node device fails many times during the auto-join.

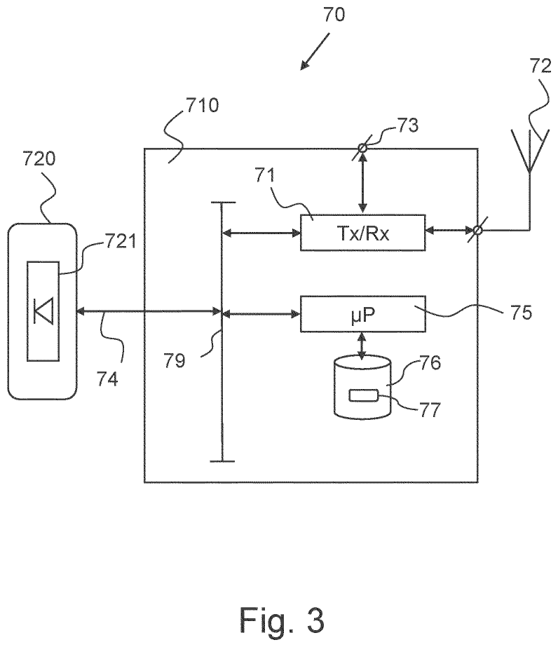

FIG. 3 illustrates, in a schematic diagram, a node device 70 arranged for joining a wireless network in accordance with the method as described above.

The node device 70 comprises a control part or control device 710 and a load such as a lighting fixture or lighting device 720, comprising a lighting module 721, preferably a Light Emitting Diode, LED, lighting module or a plurality of LED lighting modules, operation of which may be controlled by the control device 710 from or through a remote control device, such as a remote or backend server (not shown), for example.

The control device 710 operates a communication interface 71, such as a network adapter or transceiver, Tx/Rx, module arranged for short-range wireless 72 or wired 73 exchange of messages or data packets with another node device in the network, i.e. so called inter-node device communication, and with the coordinator device. Network protocols for exchanging data by networked devices or nodes may comprise ZigBee™, Bluetooth™, as well as WiFi based protocols for wireless networks, and wired bus networks such as DALI™ (Digital Addressable Lighting Interface), DSI (Digital Serial Interface), DMX (Digital Multiplex), and KNX (or KNX based systems), and other proprietary protocols.

The control device 710 further comprises at least one microprocessor, μP, or controller 75, and at least one data repository or storage or memory 76, among others for storing address information 77 of the node device itself and other node devices, such as identifiers, IDs, Media Access Control, MAC, addresses, and subscriber information of node devices. The data repository 76 may also store the number of groups, joining interval and so on needed for determining the joining time instant. Instead of the data repository 76, a separate memory or storage accessible to the at least one processor or controller 75 may be provided.

The at least one microprocessor or controller 75 communicatively interacts with and controls the communication interface 71, and the at least one data repository or storage 76 via an internal data communication and control bus 79 of the control device 710. The at least one microprocessor or controller 75 may operate one or a plurality of algorithms or applications, and the protocol stack of the node device 70 comprising the MAC sub-layer functionality to interact with the coordinator device and perform the method of being selectively commissioned by the coordinator device.

The lighting fixture or lighting device 720 connects to and is controlled from the data communication and control bus 79 by the at least one microprocessor or controller 710 via a connection link 74.

Those skilled in the art will appreciate that any electric load may be connected, via the connection link, 74 to the control bus 79 other than or in addition to a lighting fixture or lighting device 720, such as an access point device or a geographic routing device.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment, system or network.

1. A method of joining a node device into a wireless network, the network created by a coordinator device and comprising a plurality of node devices divided into a number of groups, the method comprising the steps of:
receiving, by the node device, a beacon message from the coordinator device at a first time instant, the beacon message received in response to a request message from the node device and comprising network information;
obtaining, by the node device, a group label for the node device based on the number of groups;
determining, by the node device, a joining interval for determining a joining time instant for the node device;
determining, by the node device, a first joining time instant for the node device, whereby the first joining time instant is the first time instant plus a joining period proportional to the joining interval and the group label;
transmitting, by the node device, a joining request to the coordinator device, at the first joining time instant;
when an association response is not received from the coordinator device;
determining, by the node device, a consecutive joining time instant for the node device, wherein the consecutive time instant is a joining time instant of adjacent previous transmission step plus a joining period less than that of adjacent previous transmission step;
transmitting, by the node device, a consecutive joining request to the coordinator device at the consecutive joining time instant;
wherein the determination of the consecutive joining time instant and the transmitting of the consecutive joining request are repeated until an association response is received from the coordinator device.

2. The method according to claim 1, further comprising, subsequent to the receiving step, a step of:
receiving, by the node device, a second beacon message comprising the number of groups from the coordinator device.

3. The method according to claim 1, wherein the number of groups is provided to the node device via a software or by reading from a data file available to the node device.

4. The method according to claim 1, wherein determining, by the node device, a group label for the node device based on the number of groups comprises:
determining, by the node device, the group label for the node device as a remainder obtained by a random number generated by the node device modulating the number of groups.

5. The method according to claim 1, wherein determining, by the node device, a group label for the node device based on the number of groups comprises:
determining, by the node device, the group label for the node device as a remainder obtained by a Medium Access Control, MAC, address of the node device modulating the number of groups.

6. The method according to claim 1, wherein the joining interval for determining a joining time instant for the node device is determined based on a number of node device in a group comprising the node device.

7. The method according to claim 1, wherein the joining period for determining the first joining time instant is equal to a product of the joining interval and the group label.

8. The method according to claim 1, wherein the joining period for determining the consecutive joining time instant is half of the joining period for determining the joining time instant of the adjacent previous transmission step.

9. The method according to claim 1, wherein the joining period for determining the consecutive joining time instant is set to zero when it is smaller than a threshold value.

10. The method according to claim 1, wherein a joining request other than the one sent at first joining time instant is processed with a higher priority by the coordinator device than a joining request sent at first joining time instant.

11. The method according to claim 1, wherein a random delay is appended to each joining period.

12. The method according to claim 1, further comprising a step of authenticating each other by the node device and the coordinator device.

13. A node device arranged for joining a wireless network comprising a plurality of node devices divided into a number of groups, wherein the node device comprises a processor and the processor is configured to:
receive a beacon message from the coordinator device at a first time instant, the beacon message received in response to a request message from the node device and comprising network information;
obtain a group label for the node device based on the number of groups;
determine a joining interval for determining a joining time instant for the node device;
determine a first joining time instant for the node device, whereby the first joining time instant is the first time instant plus a joining period proportional to the joining interval and the group label;
transmit a joining request to the coordinator device, at the first joining time instant;
when an association response is not received from the coordinator device;
determine a consecutive joining time instant for the node device, wherein the consecutive time instant is a joining time instant of adjacent previous transmission step plus a joining period less than that of adjacent previous transmission; and
transmit a consecutive joining request to the coordinator device at the consecutive joining time instant;
wherein the determination of the consecutive joining time instant and the transmitting of the consecutive joining request are repeated until an association response is received from the coordinator device.

14. The node device according to claim 13, comprising a lighting fixture.

15. A non-transitory computer readable storage medium storing instructions which, when executed on at least one processor, cause said at least one processor to carry out the method according to claim 1.
